(19) United States
(12) Patent Application Publication
(10) Pub. No.: US 2016/0088890 A1
(43) Pub. Date: Mar. 31, 2016

(54) ILLUMINATED SWEAT BAND

(71) Applicant: Caffey Armagh, Saint Charles, MO (US)

(72) Inventor: Caffey Armagh, Saint Charles, MO (US)

(21) Appl. No.: 14/867,348

(22) Filed: Sep. 28, 2015

Related U.S. Application Data
(60) Provisional application No. 62/056,857, filed on Sep. 29, 2014.

(51) Int. Cl. A42B 1/24; F21V 33/00; F21L 4/00; A42C 5/02

(52) U.S. Cl. CPC A42B 1/242; A42C 5/02; F21V 33/0008; F21L 4/00; F21Y 2105/006

(57) ABSTRACT

An illuminated sweatband comprising a head band consisting a fabric layer adjustably wearable around a head of a user for absorbing sweat and an electroluminescent panel removably attachable to an outer surface of the fabric layer by a fastening member. The illuminated sweatband further comprises a portable inverter housing a battery unit and a switching control, operatively connected to the electroluminescent panel. Actuating the electroluminescent panel via the switching control illuminates the entire surface area of the head band, thus making the user more visible, especially under dimly lit or dark environment.

### CROSS REFERENCE TO RELATED APPLICATIONS

This application claims priority to U.S. Provisional Patent Application No. 62/056,857, filed in the United States Patent and Trademark Office on Sep. 29, 2014. The specification of the above referenced patent application is incorporated herein by reference in its entirety.

### BACKGROUND OF THE INVENTION

A. Technical Field

The present invention generally relates to the technical field of sweat bands and more specifically relates to a head band comprising a base fabric for absorbing perspiration and an electroluminescent panel attached to the base fabric for illuminating the entire surface area of the sweat band worn around a user's head.

B. Description of Related Art

A considerable amount of population have been engaging in outdoor activities during night hours. These activities include running, walking, biking, camping, adventure sports, delivering goods and the like. From safety perspective, the person engaging in such outdoor activities should be adequately visible to others, in order to prevent mishaps such as road accidents, etc. Visibility is an important factor for the safety of people engaging in sports during night time and also for law enforcement agents, paramedics, road construction crews, delivery personnel and other workers who are required to work in low lit environments.

Head bands or sweat bands are manufactured for the sole purpose of absorbing sweat of the wearer while engaged in a strenuous physical activity. Most of the head bands or wristbands have ignored the need for improving visibility of the wearer to the surrounding public or motorists. Though, some of the headbands have begun utilizing reflective technologies and LED bulbs, reflective sweatbands require light from streetlight or vehicle headlight to function whereas LED bulbs attached to the sweat bands gives off only little lighting. A number of wearable illumination devices exists in the art which are dedicated only for the purpose of illuminating a portion of the wearer without any additional functionalities.

Therefore, there is a need in the art for an improved sweatband that illuminates the wearer, in addition to absorbing sweat produced as a result of strenuous physical activities. There is also a need in the art for a wearable sweatband providing brighter light especially in a dimly lit or dark environment.

### SUMMARY OF THE INVENTION

The present invention relates to an illuminated sweatband comprising a head band. The head band comprising a fabric layer adjustably wearable around a head of a user for absorbing sweat. The outer surface of the fabric layer is removably attached with an electroluminescent panel via a fastening member. The illuminated sweatband of the present invention further comprise a portable inverter comprising a battery unit and a switching control operatively connected to the electroluminescent panel, wherein actuating the switching control powers the electroluminescent panel thereby illuminating the entire surface area of the head band.

In an embodiment, the fabric layer may comprise materials such as cotton, wool, Terry cloth and synthetic fiber, configured to absorb sweat. In one embodiment, the fastening member may comprise Velcro straps, in which one of the fabric layer and electroluminescent panel comprise a Velcro loop layer and the other comprise a Velcro hook layer. In another embodiment, the fastening member may comprise magnets and button snaps.

In one embodiment, the portable inverter is attached to the head band such that the inverter is directly connected to the electroluminescent panel. In another embodiment, the portable inverter is operably connected to the head band or electroluminescent panel via a wire. The battery unit of the inverter may comprise a standard AAA size battery or a rechargeable Lithium battery.

In another embodiment, the illuminated sweatband of the present invention further comprise one or more design, logo, name and information printed on a surface of the electroluminescent panel. The sweatband provides 360 degree illumination by lighting the entire surface area of the band. In an embodiment, the electroluminescent panel may comprise animated features.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIG. 1 shows a perspective view of the illuminated sweatband according to an embodiment.

FIG. 2 shows a side view of the illuminated sweatband worn by a user.

FIG. 3 shows a top view of the illuminated sweatband worn by a user.

FIG. 4 shows a front exploded view of the head band.

FIG. 5 shows a rear exploded view of the head band.

FIG. 6 shows a sectional view of the head band along the line 6-6 in FIG. 3

FIG. 7 shows a side view of the illuminated sweatband according to an alternate embodiment.

FIG. 8 shows a perspective view of the illuminated sweatband according to an alternate embodiment.

FIG. 9 shows a perspective view of the illuminated sweatband according to a different embodiment.

FIG. 10 shows an exploded view of the illuminated sweatband according to a different embodiment.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

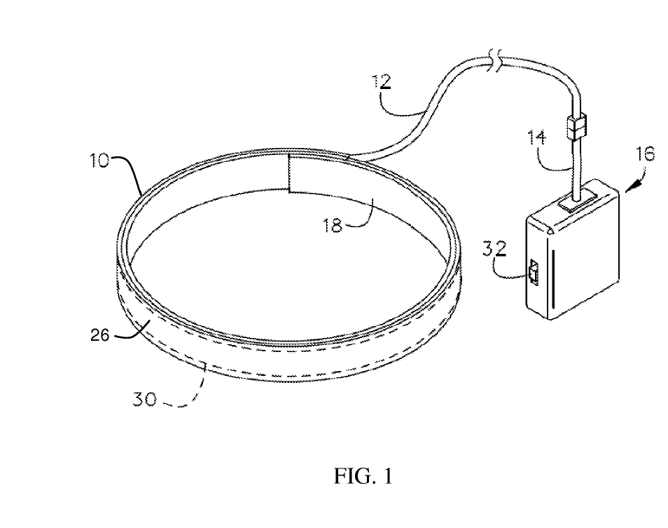

Referring to FIG. 1 showing a perspective view of the illuminated sweatband comprise a headband 10 consisting a fabric layer 18 adjustably wearable around a head of a user for absorbing sweat. The fabric layer 18 may comprise sweat absorbing material such as cotton, Terry cloth, wool and synthetic fibers. The outer surface of the fabric layer 18 is removably attached with an electroluminescent panel 26. The illuminated sweatband of the present invention further comprise a portable inverter or a power unit 16 comprising a battery unit (not shown) and a switching control 32 operatively connected to the electroluminescent panel 26, wherein actuating the switching control 32 powers the electroluminescent panel 26 thereby illuminating the entire surface area of the head band 10. The power unit 16 is operatively connected to the electroluminescent panel 26 via a power supply wire 12 extending from the panel 26, which is connected to another power supply wire 14 extending from the power unit 16. The electroluminescent panel 26 further comprise a digital image print attachment 30 attached to the outer surface.

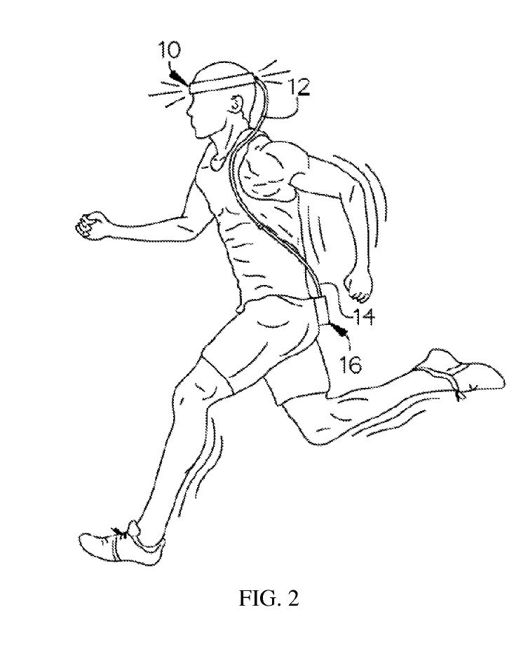

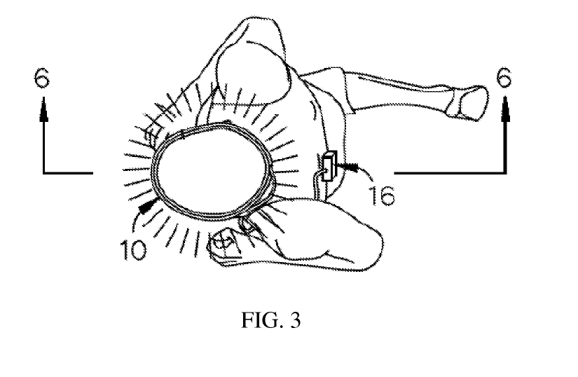

FIG. 2 and FIG. 3 shows a side view and a top view respectively of the illuminated sweatband worn by a user. In an embodiment, the headband 10 is worn around forehead of the user and the power unit 16 is worn on a waist band or clipped onto a lower garment. The headband and the power unit 16 is operatively connected by power supply wires 14, 12 which comprises a tangle-free cord that does not interfere with the physical movements of the user. In an exemplary embodiment, the user can wear the headband 10 and clip on the power unit 16 to the waistband of their garment and engage in activities like jogging, walking, running and biking among other similar activities.

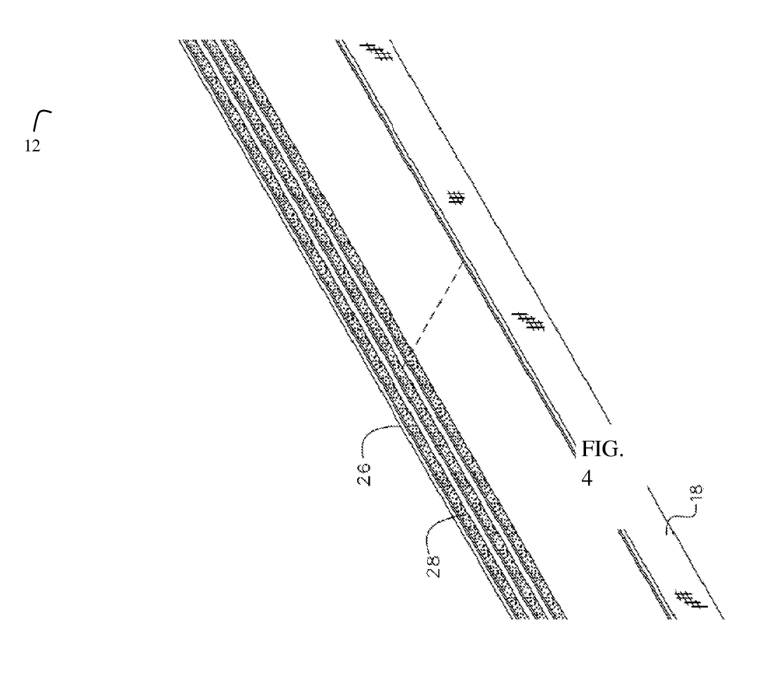

FIG. 4 shows a front exploded view of the head band 10 comprising the fabric layer 18 with a hook and loop tab 22 at one end of the fabric layer 18. The hook and loop tab 22 may comprise a Velcro tab. The size of the headband 10 can be adjusted according to the size of the user's head by the hook and loop tab 22. In another embodiment, one end of the fabric layer 18 may comprise other types of fastening such as magnets and button snaps.

In one embodiment, the electroluminescent panel 26 is removably attached to the outer surface of the fabric layer 18 via a plurality of hook and loop bands 28 such as Velcro bands present on the inner surface of the electroluminescent panel 26. The electroluminescent panel 26 is powered via the power supply wire 12. In one embodiment, one of the fabric layer 18 and electroluminescent panel 26 comprise one or more loop bands and the other comprise one or more hook bands.

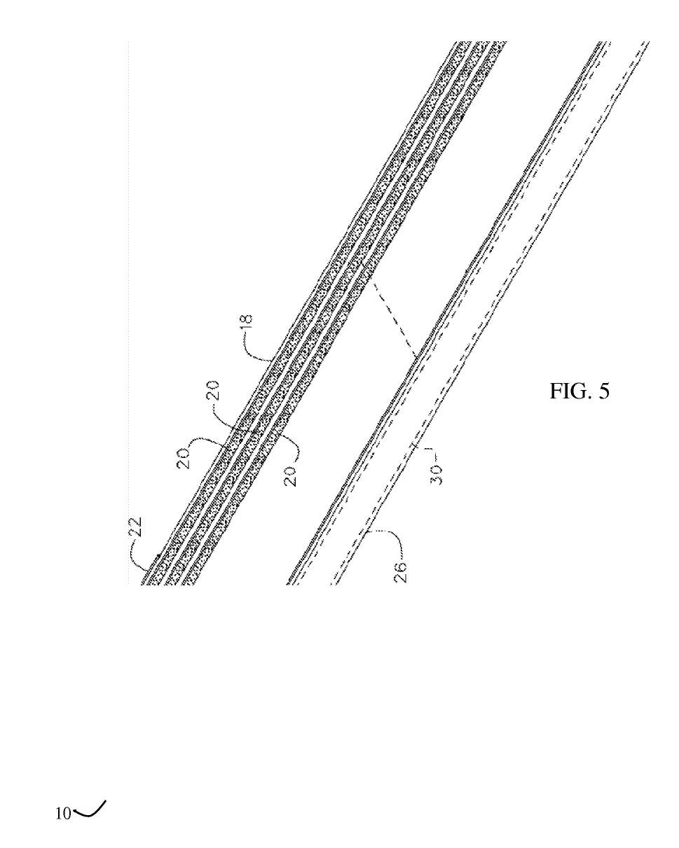

FIG. 5 shows a rear exploded view of the head band 10 comprising a digital image print attachment 30 attached to the outer surface of the electroluminescent panel 26. The attachment 30 may comprise one or more design, logo, name and information printed on the surface such that when the electroluminescent panel 26 is illuminated by power supply carried through the power supply wire 12, the information printed on the attachment 30 also gets illuminated. The inner surface of the electroluminescent panel 26 is attached via a plurality of hook and loop bands 20 present on the outer surface of the fabric layer 18. The hook and loop tab 22 present on the inner surface of the fabric layer 18 facilitates fastening of the headband 10 around the user's head. In another embodiment, the electroluminescent panel 26 can be fixedly attached by stitching to the fabric layer 18.

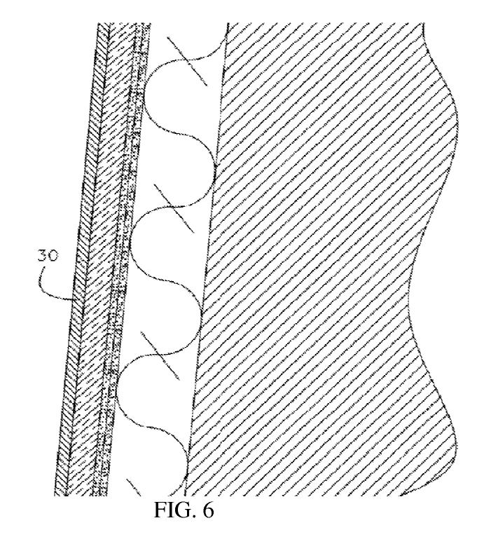

FIG. 6 shows a sectional view of the line 6-6 of the illuminated sweatband shown in FIG. 3. The headband 10 comprises the fabric layer 18 removably attached to the electroluminescent panel 26 via one or more hook and loop bands 20, 28. In one embodiment, the fabric layer 18 may comprise a plurality of loop bands horizontally extending along the length of the fabric layer 18 and the electroluminescent panel 26 may comprise a plurality of hook bands extending along the length of the panel 26. The electroluminescent panel 26 further comprise a digital image print attachment 30 on the outer surface.

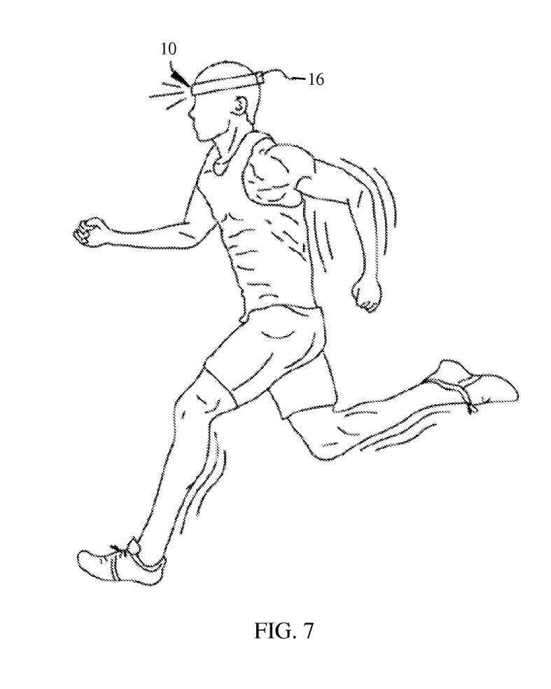

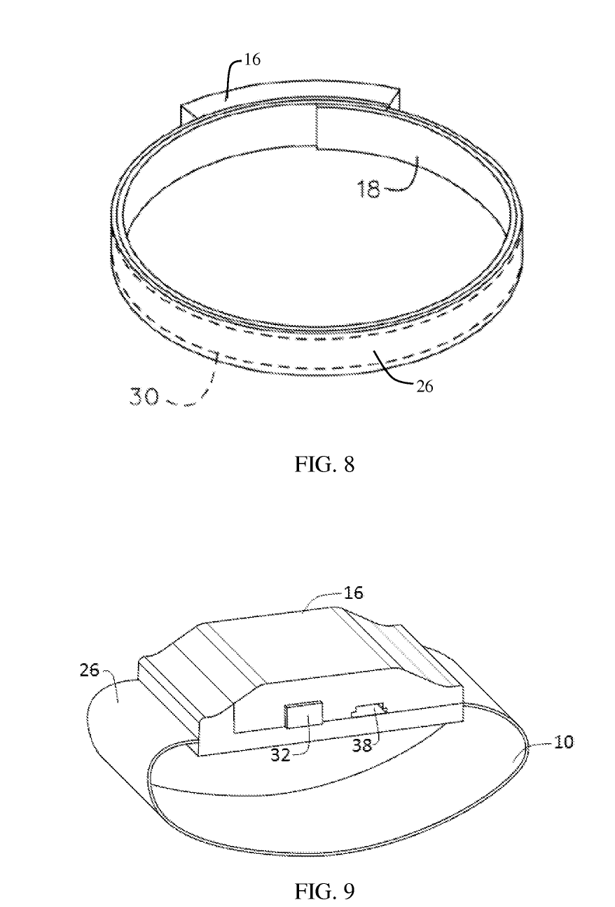

In an alternate embodiment, the illuminated sweatband may comprise the power unit 16 attached to the headband 10 as shown in FIG. 7 and FIG. 8. The headband 10 comprises a fabric layer 18 attached with an electroluminescent panel 26 which is powered by the power unit 16 attached to the headband 10. The electroluminescent panel 26 further comprise a digital image print attachment 30 attached to the outer surface. The present configuration eliminates the need of power supply wire or cord. FIG. 7 and FIG. 8 shows a side view and a perspective view respectively of the illuminated sweatband according to the alternate embodiment.

The electroluminescent panel 26 of the headband 10 is configured to provide more lighting than wearable reflective devices and LED panels. The illumination is constant and can be controlled by a small power unit with switching controls. The power unit comes with different modes of operation. For example, a simple flick of the switch to “on” position will illuminate the entire surface area of the band, another flick, causes the illumination to flash slowly, and the last causes the illumination to flash rapidly. The flashing modes greatly improves visibility in low light conditions. In an embodiment, the lighting units of the electroluminescent panel 26 may last up to 8000 hours before losing the ability to illuminate. In one embodiment, headband 10 is covered with a transparent layer of water resistant material. The dimensions and positioning of the electroluminescent panel 26 corresponds with the dimensions and positioning of the sweat absorbing fabric layer 18.

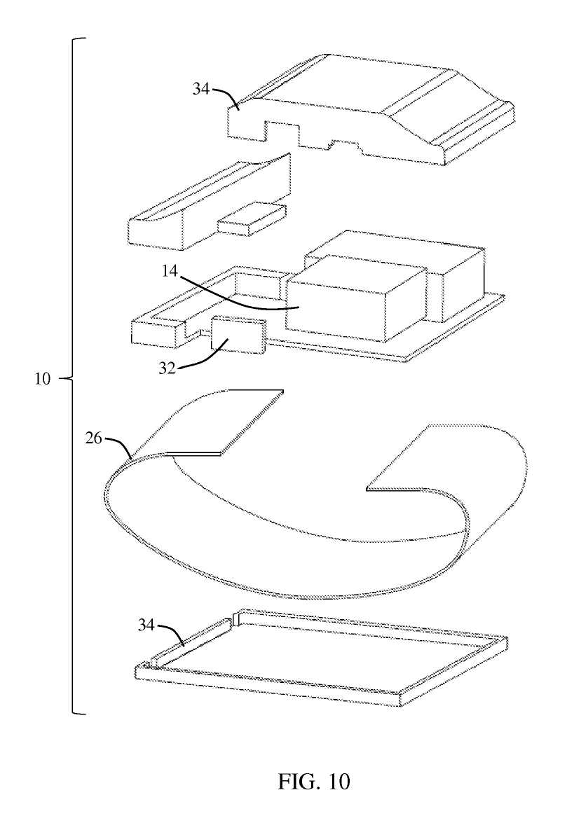

FIG. 9 and FIG. 10 shows a perspective and an exploded view of the illuminated sweatband according to a different embodiment. The sweatband 10 comprises a power unit 16 attached to the electroluminescent panel 26. The power unit 16 comprises a battery 14 and a switching control 32 disposed within an upper housing member 34 and a lower housing member 36. The switching control 32 is operable to control the illumination of the electroluminescent panel 26. The power unit 16 further comprise a charging port 38 for attaching a power cord to recharge the battery 14. The power unit 16, can be charged by way of a micro USB cable. This cable can be found as the charger for most cell phones.

In order to manufacture the above types of sweatband, one would need a plain sweatband that isn't connected to form the traditional pre-made circle shape. The sweat band may comprise a wristband or a head band with a Velcro hook patch on one end to serve as a size adjuster. There will also need to be either 2 or 3 strips of Velcro loop stitched to the outside surface of the band which allows the Velcro hook patch to be able to connect at any point on the base sweatband for adjusting according to any adult head size. Another component includes an electroluminescent. These panels can come with any kind of art, images, or logos printed on the surface. On the backside of the electroluminescent panel, 2 to 3 strips of Velcro hooks are attached to the backside surface. The strips of Velcro hooks on the panel must be in the same position as the strips of Velcro loops on the band to ensure that both pieces are in perfect alignment when being attached.

The illuminated sweatband of the present renders the wearer more visible to others, especially under dimly lighted or dark conditions. For example, people engaging in activities such as running, walking, camping, biking, sporting events, delivering items or goods, during night hours can improve their visibility to others such as public, motorists, pedestrians, etc., at least for the purpose of safety. The illuminated sweatband provides 360 degree illumination by lighting the entire surface area of the band, in addition to sweat absorbing properties. The sweatband will allow the wearer to be seen from 200 meters away. This can alert drivers of motor vehicles of the wearer's presence. In one embodiment, the illuminated sweatband can be incorporated in other headgears such as caps, hats, helmets and the like. In another embodiment, the illuminated sweatband may comprise a wristband and can be illuminated with any color, animated features and image or logos printed around the band. The sweatband can be used by sportspersons, travelers, law enforcement agents, paramedics, road construction crews, delivery personnel, or any other person who requires to work or engage in activities under low lit environments.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. An illuminated sweatband comprising:
a head band comprising a fabric layer adjustably wearable around a head of a user for absorbing sweat;
an electroluminescent panel removably attachable to an outer surface of the fabric layer by a fastening member; and
a power unit comprising a battery unit and a switching control, operatively connected to the electroluminescent panel, wherein actuating the switching control illuminates the entire surface area of the head band.

2. The illuminated sweatband of claim 1, wherein the head band comprises a hook and loop tab for fastening the head band.

3. The illuminated sweatband of claim 1, comprises a wristband.

4. The illuminated sweatband of claim 1, wherein the fabric layer comprise cotton, wool, Terry cloth and synthetic fiber.

5. The illuminated sweatband of claim 1, wherein the fastening member comprise Velcro straps, magnets and button snaps.

6. The illuminated sweatband of claim 1, wherein the power unit is attached to the head band.

7. The illuminated sweatband of claim 1, wherein the power unit is operably connected to the electroluminescent panel via a short wire or a long wire.

8. The illuminated sweatband of claim 1, wherein the battery unit comprise a rechargeable battery.

9. The illuminated sweatband of claim 1, further comprise design, logo, name and information printed on a surface of the electroluminescent panel.
